(19) United States
(12) Patent Application Publication
(10) Pub. No.: US 2020/0285355 A1
(43) Pub. Date: Sep. 10, 2020

(54) METHOD AND APPARATUS FOR CUSTOMIZING COLOR OF OBJECT ON APPLICATION

(71) Applicant: Sang Hyun SHIN, Seoul (KR)

(72) Inventor: Sang Hyun SHIN, Seoul (KR)

(21) Appl. No.: 16/812,227

(22) Filed: Mar. 6, 2020

(30) Foreign Application Priority Data
Mar. 8, 2019 (KR) 10-2019-0027125
Mar. 8, 2019 (KR) 10-2019-0027126
Oct. 1, 2019 (KR) 10-2019-0121714
Jan. 9, 2020 (KR) 10-2020-0002917
Jan. 9, 2020 (KR) 10-2020-0002918

(51) Int. Cl. G06F 3/0482; G06F 3/0486; G06F 3/0484

(52) U.S. Cl. CPC G06F 3/0482; G06F 3/04847; G06F 3/0486

(57) ABSTRACT

Provided is a method for customizing the color of an object on an application driven by a computing device. The method comprises configuring a palette including at least one palette color, displaying a color list of the palette, and customizing the color of the object by applying a palette color selected by a user from the color list to the object, wherein the at least one palette color includes a first partial color and a second partial color, which is distinguished from the first partial color.

### CROSS-REFERENCE TO RELATED APPLICATIONS

This application claims priority to Korean Patent Application No. 10-2019-0027125 filed on Mar. 8, 2019, Korean Patent Application No. 10-2019-0027126 filed on Mar. 8, 2019, Korean Patent Application No. 10-2019-0121714 filed on Oct. 1, 2019, Korean Patent Application No. 10-2020-0002917 filed on Jan. 9, 2020, and Korean Patent Application No. 10-2020-0002918 filed on Jan. 9, 2020, and in the Korean Intellectual Property Office and all the benefits accruing therefrom under 35 U.S.C. § 119, the disclosure of which is incorporated herein by reference in its entirety.

### BACKGROUND

### 1. Field

The present disclosure relates to a method and apparatus for customizing the colors of objects on an application, and more particularly, to a method and apparatus for freely customizing the colors of various objects on an application.

### 2. Description of the Related Art

Nowadays, people use social network services (SNSs), such as Facebook and Instagram, to communicate feelings and thoughts with their friends and acquaintances. These SNSs generally use basic interface styles (such as fonts, colors, layouts, designs, and the like) provided as defaults by the service providers, and it is generally difficult or highly limited for users to change the styles of objects on the SNSs to their taste.

As existing SNSs have failed to provide full customization options, users have not been able to fully express their desire of expression in social space and may easily get tired of object styles that are always the same and uniform. As a result, users' interest and participation in SNSs may decrease, hampering the activation and spread of SNSs.

### SUMMARY

An embodiment of the present disclosure is to provide a method and apparatus for customizing objects in various styles on a social network service (SNS) or an application service.

Another embodiment of the present disclosure is to provide a method and apparatus for allowing a user to easily and quickly apply various colors that suit his or her taste to objects in an application.

Still another embodiment of the present disclosure is to provide a method and apparatus for allowing a user to collect and manage various colors that suit his or her taste via an application.

Embodiments of the present disclosure are not restricted to those set forth herein. The above and other embodiments of the present disclosure will become more apparent to one of ordinary skill in the art to which the present disclosure pertains by referencing the detailed description of the present disclosure given below.

According to an embodiment of the present disclosure, a method for customizing the color of an object on an application is driven by a computing device, the method comprises configuring a palette including at least one palette color, displaying a color list of the palette, and customizing the color of the object by applying a palette color selected by a user from the color list to the object, wherein the at least one palette color includes a first partial color and a second partial color, which is distinguished from the first partial color.

According to an embodiment of the present disclosure, an apparatus for customizing the color of an object comprises a processor, a memory loading therein a computer program that is executed by the processor, and a storage storing the computer program, wherein the computer program includes instructions to perform operations of configuring a palette including at least one palette color, displaying a color list of the palette, and customizing the color of the object by applying a palette color selected by a user from the color list to the object, wherein the at least one palette color includes a first partial color and a second partial color, which is distinguished from the first partial color.

### BRIEF DESCRIPTION OF THE DRAWINGS

The above and other embodiments and features of the present disclosure will become more apparent by describing in detail embodiments thereof with reference to the attached drawings, in which:

FIG. 1 is a flowchart illustrating a method of customizing the color of an object according to some embodiments of the present disclosure;

FIG. 2 is a detailed flowchart illustrating S100 of FIG. 1;

FIG. 3 illustrates components of a palette according to some embodiments of the present disclosure;

FIG. 4 illustrates the configuration and characteristics of a palette color according to some embodiments of the present disclosure;

FIGS. 5 through 7 illustrate how to apply the method of customizing the color of an object according to some embodiments of the present disclosure to a screen image;

FIGS. 8 through 11 illustrate how to apply the method of customizing the color of an object according to some embodiments of the present disclosure to a “my room” of an application;

FIGS. 12 to 13B illustrate the configuration and characteristics of a controller 1240 of FIG. 9;

FIGS. 14 through 19 illustrate various modifications and extensions of the method of customizing the color of an object according to some embodiments of the present disclosure; and

FIG. 20 is a hardware configuration diagram illustrating an exemplary computing device that can implement an apparatus according to various embodiments of the present disclosure.

### DETAILED DESCRIPTION

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present invention, when it is determined that the detailed description of the related well-known configuration or function may obscure the gist of the present invention, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the invention. In this specification, the singular also includes the plural unless specifically stated otherwise in the phrase.

In addition, in describing the component of this invention, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

The terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Hereinafter, some embodiments of the present invention will be described in detail with reference to the accompanying drawings.

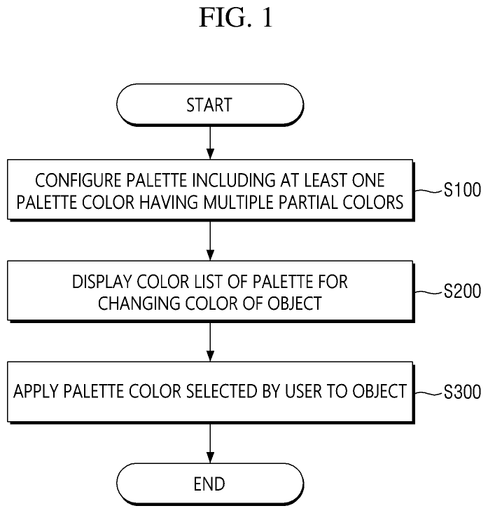

FIG. 1 is a flowchart illustrating a method of customizing the color of an object according to some embodiments of the present disclosure. Each step of the method of FIG. 1 may be implemented as one or more instructions that can be executed by the processors of a computing device.

Here, the term “instruction” refers to a series of computer-readable commands that are grouped by function, i.e., an element of a computer program that is executed by a processor. Each step of the method of FIG. 1 may be executed by a single physical computing device. Alternatively, the steps of the method of FIG. 1 may be divided between, and executed by, multiple computing devices. For example, some steps of the method of FIG. 1 may be executed by a first computing device, and the other steps of the method of FIG. 1 may be executed by a second computing device.

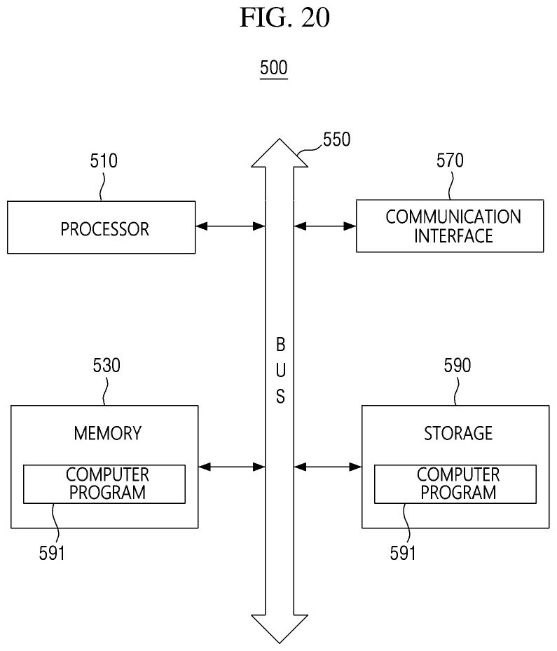

The method of FIG. 1 may be performed in various systems or environments. For example, the method of FIG. 1 may be executed by a computing device 500 of FIG. 20. A system and an environment in which the method of FIG. 1 is to be performed will be described later with reference to FIG. 20. The order in which the steps of the method of FIG. 1 are performed may vary.

A method of customizing the color of an object according to some embodiments of the present disclosure will hereinafter be described with reference to FIG. 1. It is assumed that the steps of the method of FIG. 1 are performed by the computing device 500 of FIG. 20.

Referring to FIG. 1, in S100, the computing device 500 configures a palette with one or more palette colors, each having multiple partial colors. The computing device 500 may configure a palette using at least some of colors held by a user, in accordance with input from the user. Each of the palette colors of the palette may have multiple partial colors. For example, each of the palette colors of the palette may include a first partial color disposed in a first region, a second partial color disposed in a second region, and a third partial color disposed in a third region, but the present disclosure is not limited thereto. That is, the number of partial colors included in each of the palette colors of the palette.

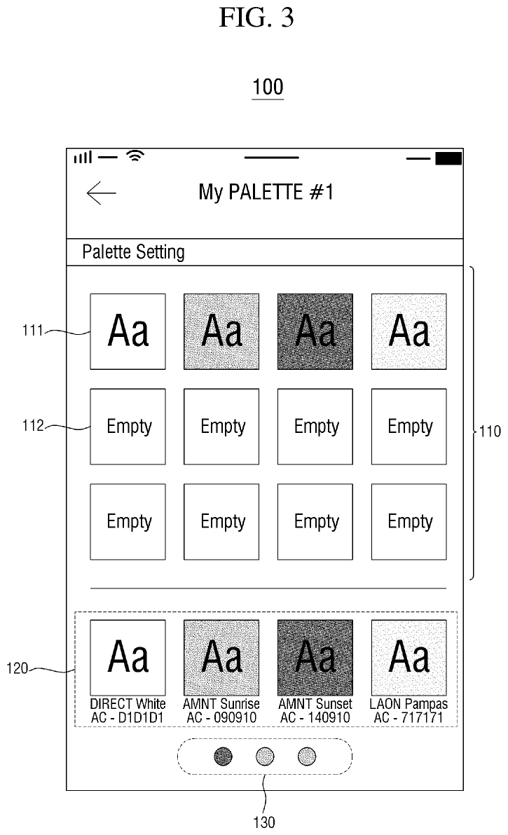

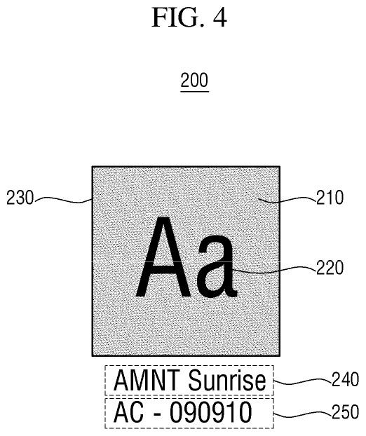

The configuration of a palette using one or more palette colors and the partial colors of each of the palette colors will be described later in further detail with reference to FIGS. 3 and 4.

In S200, the computing device 500 displays a color list of the palette for changing the color of an object. The color list may include one or more palette colors of the palette configured in S100.

In one embodiment, the color list may include all the palette colors included in the palette or only some of the palette colors included in the palette. In a case where only some of the palette colors included in the palette are displayed, only a palette color designated in advance for the type of the object or a palette color selected by the user may be configured to be displayed.

In S300, the computing device 500 may apply a palette color selected by the user from the color list to the target object. If the selected palette color has multiple partial colors, the partial colors of the selected palette color may be applied to different elements of the object.

For example, if the object consists of multiple elements (e.g., the background, buttons, letters, and the like) and the selected palette color has first and second partial colors, the first and second partial colors may be automatically applied to the respective elements of the object in response to the selected palette color being applied to the object.

Specifically, if the first partial color of the selected palette color corresponds to the background of the object and the second partial color of the selected palette color corresponds to button and letter parts of the object, the computing device 500 may automatically change the background color of the object into the first partial color of the selected palette color and the button and font colors of the object into the second partial color in response to the selected palette color being applied to the object. That is, a variety of colors can be applied at once to the object simply by selecting a single palette color without designating colors to be applied to individual elements of the object, and this will be described later in further detail with reference to FIG. 3.

According to the method of FIG. 1, the user can easily and quickly apply various colors that suit his or her taste to objects in an application and can thus freely customize various styles of objects in a social network service (SNS) or an application service. Therefore, the diversity of expression can be improved, and the user's interest and participation in an SNS or an application service can be heightened.

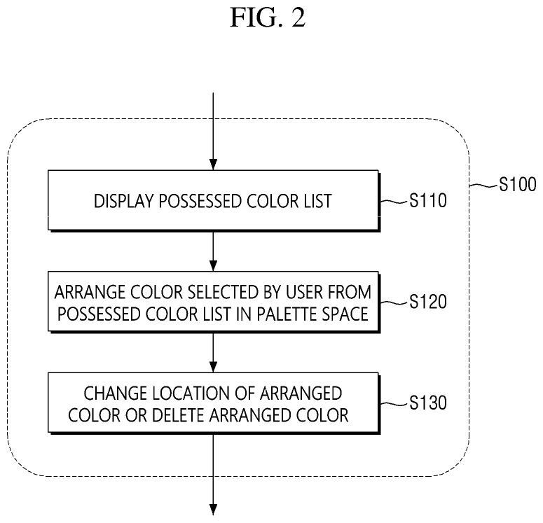

FIG. 2 is a detailed flowchart illustrating S100 of FIG. 1. Steps for configuring a palette color will hereinafter be described with reference to FIG. 2.

Referring to FIG. 2, in S110, the computing device 500 displays a color list including colors held by the user. Here, the colors held by the user may include colors purchased from a “market” on an application, colors provided as defaults by the service provider of the application, colors received as rewards from events or from the fulfillment of particular conditions, colors scrapped from other people's palettes, or colors newly created by combining existing colors held by the user.

The scrapping of other people's palettes will hereinafter be described. When the user visits another person's personal space or homepage, an inquiry button for viewing the person's personal space or homepage, an inquiry button for viewing the person's palette screen is provided. If the user clicks the inquiry button, the person's palette screen is displayed, and the user can select and scrap any colors of his or her interest from the displayed palette screen. The scrapped colors may be added to the user's list of colors so that the user can arrange the scrapped colors in his or her palette and can use them later in customizing the color of the object.

In S120, the computing device 500 arranges one or more colors selected by the user from the displayed color list in a palette in accordance with the user's manipulation. The palette is a space in which colors to be used in customizing the color of an object are collected. The palette may include spaces purchased by the user from the “market” on the application, spaces provided as defaults by the service provider of the application, or spaces received as rewards from events or from the fulfillment of particular conditions.

In S130, the computing device 500 changes the locations of the arranged colors in the palette or deletes the arranged colors in accordance with the user's manipulation. In other words, even if the configuring of the palette is complete, the user can freely edit or modify the palette afterwards as necessary. For example, if the user's preference or priority of colors is changed after the configuring of the palette, the user can freely change the locations of, and the order between, the arranged colors in the palette in accordance with the changed preference or priority of colors. In another example, if the user wishes to delete a particular color from the palette, the user can delete the particular color from the palette.

FIG. 3 illustrates a palette according to some embodiments of the present disclosure. Referring to FIG. 3, a palette configuring screen 100 includes a palette 110 and a possessed color list 120.

The palette 110 is a space in which colors to be used in customizing the colors of objects are collected. The possessed color list 120 shows colors held or possessed by the user. The user chooses (or drags and drops) colors from the possessed color list 120 and arranges the chosen colors in the palette 110.

As illustrated in FIG. 3, the palette 110 may include a plurality of sections, and a single palette color may be disposed in each of the sections. Sections 111 in which colors are arranged may be displayed in the corresponding colors to indicate the presence of the corresponding colors therein. Sections 112 where no colors are arranged may be displayed in white or may be marked as “Empty” to indicate the absence of colors therein.

In one embodiment, the palette configuring screen 100 may further include a navigation bar 130. The navigation bar 130 may be referenced when the palette 110 or the possessed color list 120 is not displayed as a whole, but displayed only in part. For example, a first button in the navigation bar 130 may indicate that a first page of the possessed color list 120 is being displayed, a second button in the navigation bar 130 may indicate that a second page of the possessed color list 120 is being displayed, and a third button in the navigation bar 130 may indicate that a third page of the possessed color list 120 is being displayed.

As already mentioned above with reference to FIG. 2, the colors in the possessed color list 120 may include colors purchased from a “market” on an application, colors provided as defaults by the service provider of the application, colors received as rewards from events or from the fulfillment of particular conditions, colors scrapped from other people's palettes, or colors newly created by combining existing colors held by the user.

The palette 110 may include spaces purchased by the user from the “market” on the application, spaces provided as defaults by the service provider of the application, or space received as rewards from events or from the fulfillment of particular conditions. The spaces of the palette 110 may refer to the sections of the palette 110, illustrated in FIG. 3.

As already mentioned above, even after the configuring of the palette 110 is completed by arranging the colors in the possessed color list 120 in the palette 110, the user can freely edit or modify the palette 110 afterwards as necessary. That is, if the user's preference or priority of colors is changed after the configuring of the palette 110, the user can freely change the locations of, and the order between, the colors in the palette 110 in accordance with the changed preference or priority of colors. Also, the user can delete a particular color from the palette 110. The same colors may be redundantly arranged in the palette 110. For example, the color arranged in a first section 111 may also be arranged redundantly in a fifth section 112.

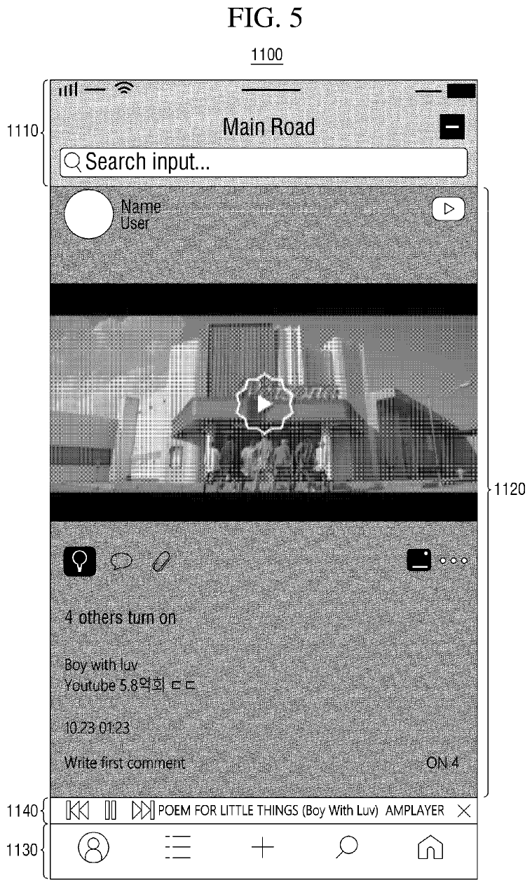

Once the configuring of the palette 110 is complete, the user can invoke palette colors that form the palette 110 from an “edit” menu to change the color of an object. The invoked palette colors may be listed in the order of arrangement in the palette 110 or in accordance with their locations in the palette 110. This will be described later in further detail with reference to FIG. 5.

FIG. 4 illustrates the configuration and characteristics of a palette color according to some embodiments of the present disclosure. Specifically, FIG. 4 illustrates an exemplary palette color 200 arranged in the palette 110 of FIG. 3. Referring to FIG. 4, the palette color 200 may include three partial colors, i.e., first second, and third partial colors 210, 220, and 230, but the present disclosure is not limited thereto. That is, the number of partial colors included in the palette color 200 is not particularly limited. Alternatively, the palette color 200 may include only two partial colors or four or more partial colors.

As illustrated in FIG. 4, the first, second, and third partial colors 210, 220, and 230 of the palette color 200 may be displayed in different regions in the palette color 200. For example, the first partial color 210 may be displayed in a first region (e.g., a background region) of the palette color 200, the second partial color 220 may be displayed in a second region (e.g., a font region) of the palette color 200, and the third partial color 230 may be displayed in a third region (e.g., an edge region) of the palette color 200.

In one embodiment, the first, second, and third partial colors 210, 220, and 230 of the palette color 200 may be configured in advance to correspond to particular elements of an object. For example, one partial color among the partial colors 210, 220, 230 may be configured in advance to correspond to a first element (e.g., a background, a button background, a status bar, or a title bar) of an object, another partial color among the partial colors 210, 220, 230 may be configured in advance to correspond to a second element (e.g., a letter, a number, a character, or an icon of a button) of the object, and the other partial color among the partial colors 210, 220, 230 may be configured in advance to correspond to a third element (e.g., an edge) of the object.

In another example, one partial color among the partial colors 210, 220, 230 may be configured in advance to correspond to a first element (e.g., a background, a button background, a status bar, or a title bar) of an object, another partial color among the partial colors 210, 220, 230 may be configured in advance to correspond to the second element (e.g., a letter, a number, a character, or an icon of a button) of the object, and the other partial color among the partial colors 210, 220, 230 may be configured in advance to be applied, instead of the one partial color or the another partial color, to the first or second element of the object, only if a particular event occurs in the first or second element of the object. For example, when there is no event, a button icon may be displayed in the second partial color 220. On the contrary, when a particular event occurs in the button icon, for example, when the button icon is being touched, the third partial color 230, instead of the second partial color 220, may be applied to the button icon. That is, the color of the button icon may be changed from the second partial color 220 to the third partial color 230.

In one embodiment, the first, second, and third partial colors 210, 220, and 230 may swap their display locations. For example, in a case where a reverse function (not illustrated) is executed, the first and second partial colors 210 and 220 may swap their display locations so that the first partial color 210 may be displayed in the second region (or the font region) and the second partial color 220 may be displayed in the first region (or the background region).

Similarly, the first, second, and third partial colors 210, 220, and 230 of the palette color 200 may swap their respective object elements. For example, if the first and second partial colors 210 and 220 are initially configured to correspond to first and second elements, respectively, of an object, the first and second partial colors 210 and 220 may be changed by the reverse function to correspond to the second and first elements, respectively, of the object.

In one embodiment, the palette color 200 may be created by combining partial colors from other palette colors. For example, the computing device 500 may select one of the partial colors of a first palette color and one of the partial colors of a second palette color from the palette 110 and may create a third palette color by combining the selected partial colors. In this example, the selected partial color of the first palette color and the selected partial color of the second palette color may be combined as first and second partial colors of the third palette color, or as the second and first partial colors, respectively, of the third palette color.

In one embodiment, the palette color 200 may be created by mixing partial colors from other palette colors. For example, the computing device 500 may select one of the partial colors of the first palette color and one of the partial colors of the second palette color from the palette 110, may create a new color by mixing the selected partial colors, and may create a third palette color including the new color. In this example, the third palette color may be a solid color including only the new color or may be a complex color including the new color as a partial color.

In one embodiment, the palette color 200 may be created by combining and mixing partial colors from other palette colors. For example, the computing device 500 may select one of the partial colors of the first palette color and one of the partial colors of the second palette color from the palette 110, may create a new color by mixing the selected partial colors, and may create a third palette color including not only the new color, but also at least one of the selected partial colors, as partial colors.

In one embodiment, the palette color 200 may be a solid color, a gradation color, a color having a pattern or design, or a combination thereof. For example, the palette color 200 may consist of a solid color, a gradation color, or a color having a pattern or design alone, or consist of the combination of various types of colors such as a gradation color, a color having a pattern or design, and a solid color as first, second, and third partial colors thereof.

In one embodiment, the palette color 200 may further include name sections (240 and 250), which indicate the names of the partial colors of the palette color 200. The name sections (240 and 250) may include the names of all the partial colors of the palette color 200 or the names of only some of the partial colors of the pallet color 200. For example, as illustrated in FIG. 4, the name sections (240 and 250) may include a first partial color name 240 and a third partial color name 250. Alternatively, as illustrated in FIG. 3, for simplicity, the name sections (240 and 250) may not be displayed in the palette 110, but may be displayed only in the possessed color list 120.

FIGS. 5 through 7 illustrate how to apply the method of customizing the color of an object according to some embodiments of the present disclosure to a screen image.

Specifically, FIG. 5 illustrates an application screen 1100. Referring to FIG. 5, the application screen 1100 may include an application head 1110, an application body 1120, an application bottom 1130, and a contents play bar 1140.

The application head 1110, the application body 1120, the application bottom 1130, and the contents play bar 1140 are illustrated as being objects that form the application screen 1100, but the present disclosure is not limited thereto. That is, the application screen 1100 may include only some of the application head 1110, the application body 1120, the application bottom 1130, and the contents play bar 1140 and may further include other objects.

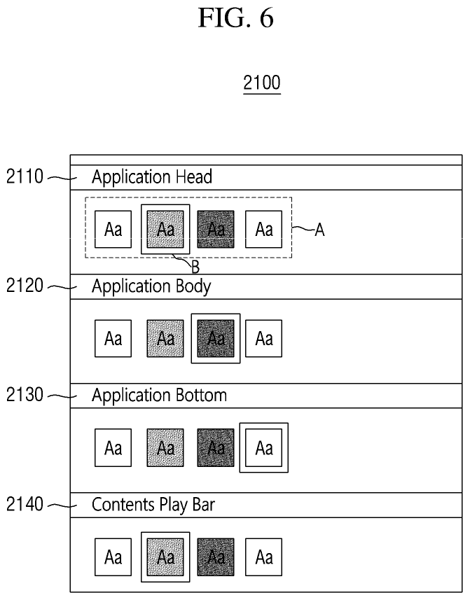

FIG. 6 illustrates a palette menu 2100 for customizing the color of each object in the application screen 1100. Referring to FIG. 6, the palette menu 2100 may include a plurality of submenus (2110, 2120, 2130, and 2140) corresponding to a plurality of objects (1110, 1120, 1130, and 1140). For example, the palette menu 2100 may include a first submenu 2110 corresponding to the application head 1110, a second submenu 2120 corresponding to the application body 1120, a third submenu 2130 corresponding to the application bottom 1130, and a fourth submenu 2140 corresponding to the contents play bar 1140.

A list A of palette colors that constitute a palette 110 is displayed in each of the submenus (2110, 2120, 2130, and 2140). The palette colors may be displayed in the order of arrangement in the palette 110 or in accordance with their locations in the palette 110. That is, a palette color arranged at the forefront of the palette 110 may be displayed at the forefront of the list A, and a palette color arranged at the end of the palette 110 may be displayed at the end of the list A. An identifier B may be displayed in each of the submenus (2110, 2120, 2130, and 2140) to distinguish a palette color being selected by the user from other palette colors. FIG. 6 shows that a second palette color is selected in the first submenu 2110, that a third palette color is selected in the second submenu 2120, that a fourth palette color is selected in the third submenu 2130, and that the second palette color is selected in the fourth submenu 2140. The same palette colors may be selected in the submenus (2110, 2120, 2130, and 2140). That is, referring to FIG. 6, the second palette color may be selected in both the first and fourth submenus 2110 and 2140.

The palette colors selected in the submenus (2110, 2120, 2130, and 2140) are applied to the objects corresponding to the submenus (2110, 2120, 2130, and 2140). For example, the palette color selected in the first submenu 2110 may be applied to the application head 1110 so that the color of the application head 1110 can be customized.

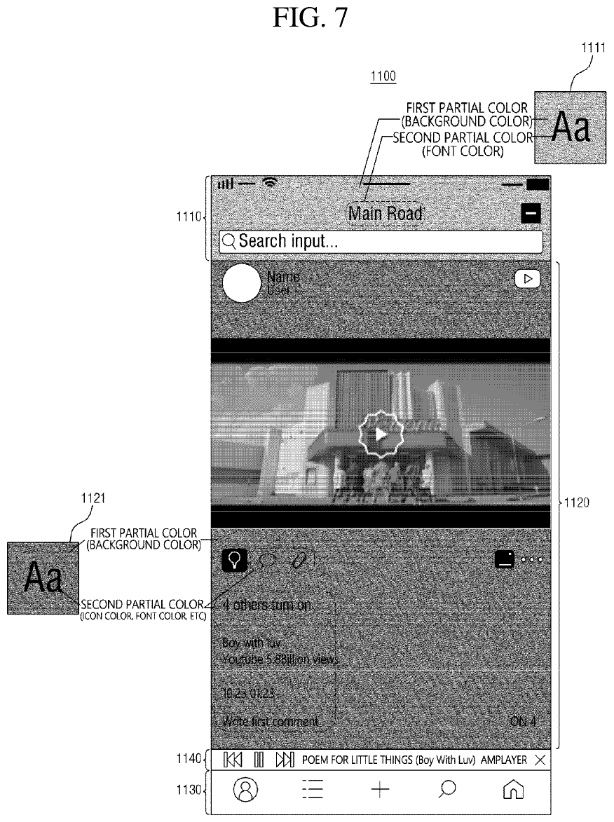

FIG. 7 illustrates an application screen 1100 obtained by color customization via the first palette menu 2100. Referring to FIG. 7, a palette color 1111 (i.e., the second palette color in the list A) is selected for the application head 1110 so that a first partial color and a second partial color of the palette color 1111 are applied to a first element (i.e., a background) and a second element (i.e., a letter), respectively, of the application head 1110. Similarly, a palette color 1121 (i.e., the third palette color in the list A) is selected for the application body 1120 so that a first partial color and a second partial color of the palette color 1121 are applied to a first element (i.e., a background) and a second element (i.e., an icon/letter), respectively, of the application body 1120. For convenience, the customization of the colors of only the application head 1110 and the application body 1120 has been described above, but the color of the contents play bar 1140 can also be customized in a similar manner.

The types of elements of an object that correspond to respective partial colors may differ from one object to another object. For example, the background of the application head 1110 may be designated as a first object element corresponding to a first partial color, and the letters in the application head 1110 may be designated as second object elements corresponding to a second partial color. On the contrary, the background of the application body 1120 may be designated as a first object element corresponding to the first partial color, but the letters, the icons, and the comments in the application body 1120 may be designated as second object elements corresponding to the second partial color. Similarly, the background of the application bottom 1130 may be designated as a first object element corresponding to the first partial color, and the icons in the application bottom 1130 may be designated as second object elements corresponding to the second partial color. On the contrary, the background of the contents play bar 1140 may be designated as a first object element corresponding to the first partial color, but the letters and the buttons in the contents play bar 1140 may be designated as second object elements corresponding to the second partial color.

In one embodiment, the number of partial colors applied to each object may vary. For example, two partial colors (i.e., the first and second partial colors) of the palette color 1111 may be applied to the application head 1110, and three partial colors (i.e., the first, second, and third partial colors) of the palette color 1121 may be applied to the application body 1120. In this example, if a particular event (e.g., a touch from the user) occurs in the elements of each of the application head 1110 and the application body 1120, the application head 1110 does not change, but the color of the element (e.g., the icons) of the application body 1120 where the particular event has occurred may be changed into the third partial color.

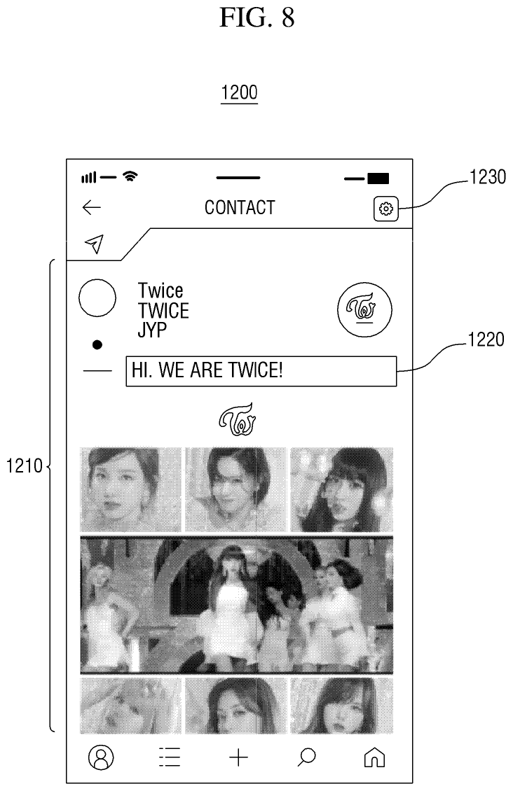

FIGS. 8 through 11 illustrate how to apply the method of customizing the color of an object according to some embodiments of the present disclosure to a “my room” of an application.

Specifically, FIG. 8 illustrates a “my room” screen 1200 of the user. Referring to FIG. 8, a “my room” may be a personal space or homepage on an application. Objects of the “my room” may include a master style 1210 and/or an individual element style 1220 depending on their type. The master style 1210, which is the general style of the “my room” screen 1200, includes the background, font, and tone of the “my room”. The individual element style 1220, which is the style of each individual element of the “my room” screen 1200, includes the background, font, and tone of a particular element (e.g., a notification bar, a badge or etc.) of the “my room” screen 1200.

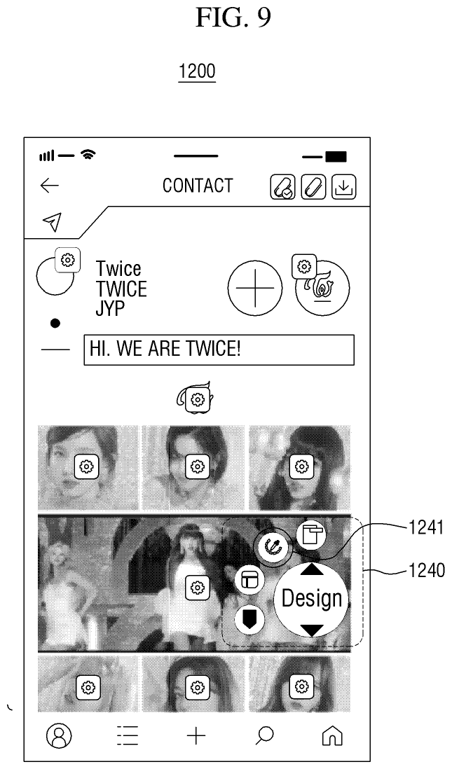

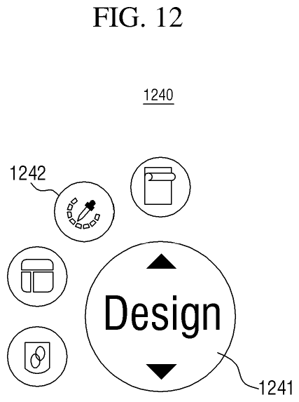

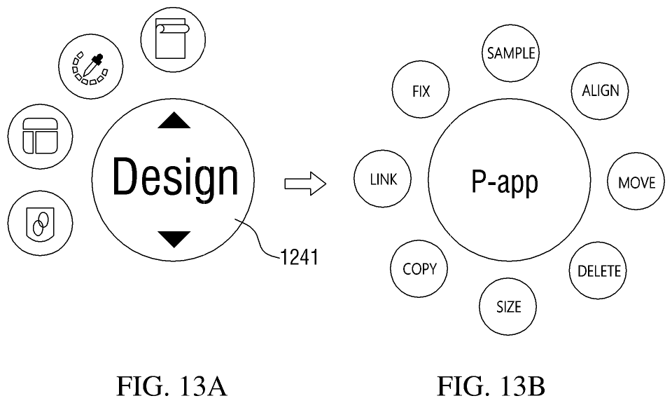

In order to customize the colors of objects on the “my room” screen 1200, the user may invoke a palette menu by selecting a settings button 1230. In one embodiment, if the settings button 1230 is selected, the palette menu may be readily called in response to the selection of the settings button 1230. In another embodiment, if the settings button 1230 is selected, a controller 1240 of FIG. 9 may be called first, and then, the palette menu may be invoked in response to the selection of a palette button 1241 of the controller 1240. The configuration and the functions of the controller 1240 will be described later with reference to FIGS. 12 to 13B.

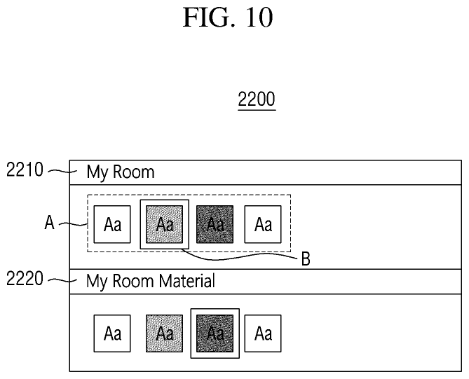

An exemplary palette menu 2200 is as illustrated in FIG. 10. Referring to FIG. 10, the palette menu 2200 may include a plurality of submenus (2210 and 2220) corresponding to a plurality of objects (1210 and 1220) of the “my room” screen 1200. For example, the palette menu 2200 may include a first submenu 2210 corresponding to the master style 1210 and a second submenu 2220 corresponding to the individual element style 1220.

In the embodiment of FIG. 10, like in the embodiment of FIG. 6, a list A of palette colors that constitute a palette 110 is displayed in each of the submenus (2210 and 2220). The palette colors may be displayed in the order of arrangement in the palette 110 or in accordance with their locations in the palette 110. That is, a palette color arranged at the forefront of the palette 110 may be displayed at the forefront of the list A, and a palette color arranged at the end of the palette 110 may be displayed at the end of the list A. An identifier B may be displayed in each of the submenus (2210 and 2220) to distinguish a palette color being selected by the user from other palette colors. FIG. 10 shows that a second palette color is selected in the first submenu 2210, and that a third palette color is selected in the second submenu 2220.

The palette colors selected in the submenus (2210 and 2220) are applied to the objects corresponding to the submenus (2210 and 2220). For example, the palette color selected in the first submenu 2210 may be applied to the master style 1210 so that the general color of the “my room”, including the color of the background of the “my room”, can be customized. Similarly, the palette color selected in the second submenu 2220 may be applied to the individual element style 1220 so that the color of each individual element of the “my room”, such as a badge, the settings button, and a notification bar, can be customized.

The palette color selected in the first submenu 2210 may include a plurality of partial colors, which correspond to the respective elements of the master style 1210. For example, a first partial color of the palette color selected in the first submenu 2210 may be applied to the background of the master style 1210, and a second partial color of the palette color selected in the first submenu 2210 may be applied to text or figure of the master style 1210.

Similarly, the palette color selected in the second submenu 2220 may include a plurality of partial colors, which correspond to the respective elements of the individual element style 1220. For example, a first partial color of the palette color selected in the second submenu 2220 may be applied to the background of the individual element style 1220, and a second partial color of the palette color selected in the second submenu 2220 may be applied to text or figure of the individual element style 1220.

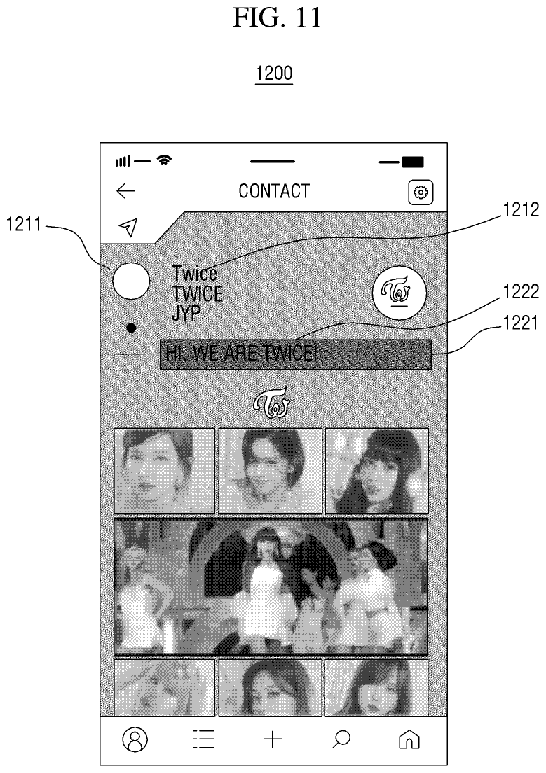

FIG. 11 illustrates a “my room” screen 1200 obtained by applying palette colors to the master style 1210 and the individual element style 1220 via the palette menu 2200. Referring to FIG. 11, a background 1211 of the master style 1210 is customized with the first partial color of the palette color selected in the first submenu 2210, and text 1212 of the master style 1210 is customized with the second partial color of the palette color selected in the first submenu 2210. Similarly, a background 1221 of the individual element style 1220 is customized with the first partial color of the palette color selected in the second submenu 2220, and text 1222 of the individual element style 1220 is customized with the second partial color of the palette color selected in the second submenu 2220.

FIGS. 12 to 13B illustrate the configuration and characteristics of the controller 1240 of FIG. 9. Specifically, FIG. 12 illustrates an exemplary controller 1240. Referring to FIG. 12, the controller 1240 includes function buttons for performing various functions of an application.

As illustrated in FIG. 12, the controller 1240 includes a large circle 1241 in the middle and small circles 1242 around the large circle 1241. The large circle 1241 in the middle of the controller 1240 may be surrounded by the small circles 1242.

The large circle 1241 indicates the type of function buttons provided by the controller 1240. For example, the large circle 1241 is marked as “Design” and indicates that function buttons currently being displayed in the controller 1240 are for design.

Individual functions that can be executed by the application are allocated to the small circles 1242. For example, if the image of a palette is displayed in one of the small circle 1242, the function of invoking a palette menu may be executed in response to the selection of the corresponding small circle 1242.

FIG. 12 illustrates the controller 1240 as being a design tool, but the present disclosure is not limited thereto. For example, the controller 1240 may be a text editing tool including “change font” and “align” functions, an effect editing tool including “shadow”, “blur”, “rotate”, “opacity”, and “watercolor effect” functions, or a complex tool including “paint”, Photoshop, Illustrator, Excel, and Premiere functions.

In one embodiment, the function type of the controller 1240, indicated by the large circle 1241, may be modified. Also, the individual functions represented by the small circles 1242 may be modified, or new individual functions may be added.

FIGS. 13A and 13B illustrate how to change the type of function buttons provided by the controller 1240. As already mentioned above, the type of function buttons provided by the controller 1240 is not particularly limited. For example, the controller 1240 may be switched from a first type of function buttons to a second type of function buttons.

Assuming that the controller 1240 is a design tool, as illustrated in FIG. 13A, the type of function buttons provided by the controller 1240 is converted in response to the large circle 1241 in the middle being touched. Then, referring to FIG. 13B, the function buttons provided by the controller 1240 are converted into the function buttons of a P-App editing tool.

The controller 1240 can be freely moved on the application via a touch-and-drag motion.

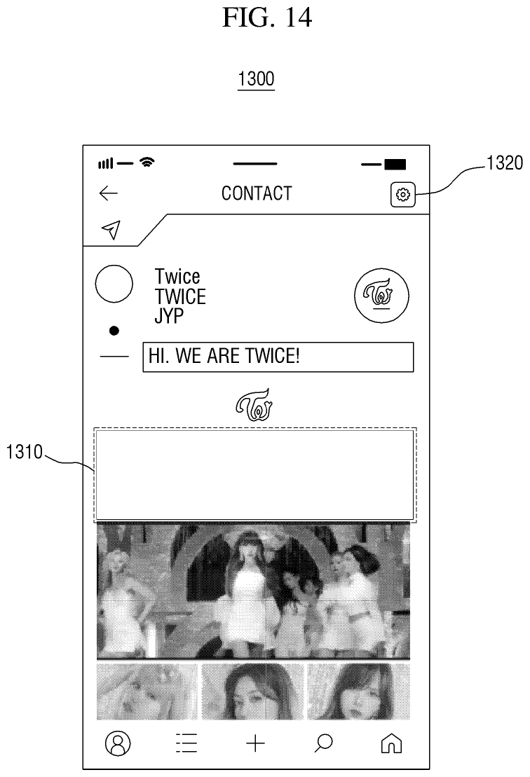

FIGS. 14 through 19 illustrate various modifications and extensions of the method of customizing the color of an object according to some embodiments of the present disclosure.

Specifically, FIG. 14 illustrates an embodiment of the customization of the color of a P-App object. A P-App, which is a user interface tool for displaying the result of execution of an application program by a computing device or for manipulating an application program, may include widgets or gadgets.

Referring to FIG. 14, there exists an empty space 1310 on a screen 1300. In order to install a P-App in the empty space 1310, the user may select a settings button 1320 to call a P-App list.

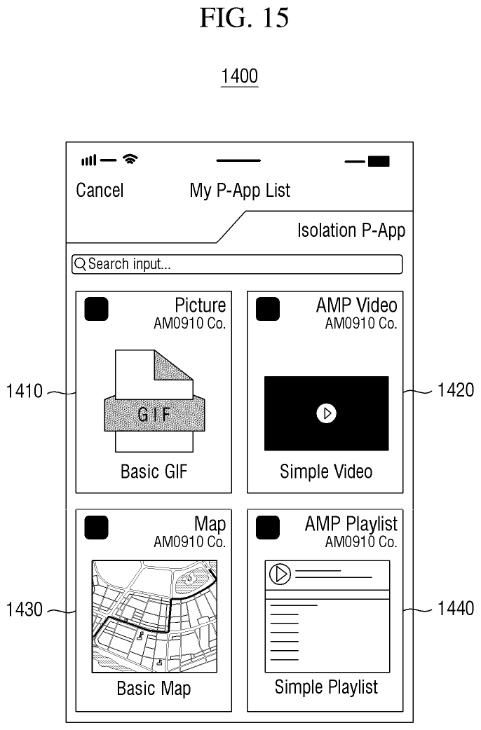

FIG. 15 illustrates an exemplary P-App list 1400. Referring to FIG. 15, the P-App list 1400 may include various types of P-Apps. For example, the P-App list 1400 may include a picture P-App 1410, a video P-App 1420, a map P-App 1430, and a playlist P-App 1440. The user may arrange the P-Apps in the P-App list 1400 in the empty space 1310 on the screen 1300.

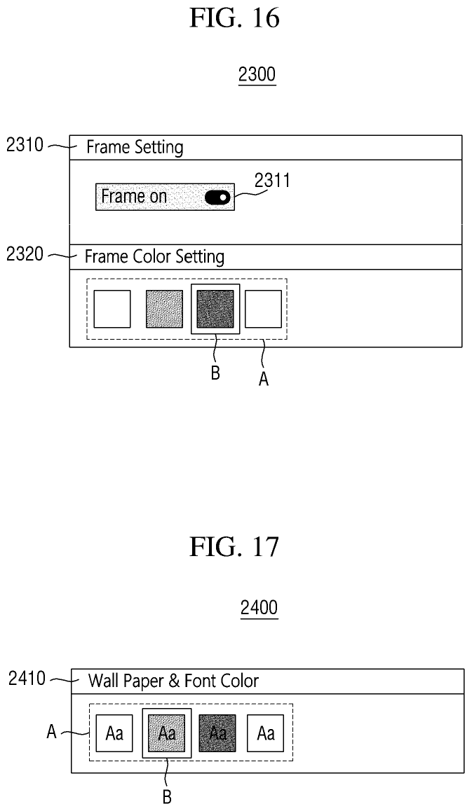

During or after the arrangement of the P-Apps in the P-App list 1400 in the empty space 1310 on the screen 1300, the user may customize the colors of the P-Apps. FIGS. 16 through 18 illustrate exemplary palette menus 2300, 2400, and 2500 for customizing the colors of P-Apps. Referring to FIGS. 16 through 18, each of the palette menus 2300, 2400, and 2500 may be called via a settings page of each P-App, which is displayed by pressing a settings button on the corresponding P-App. Alternatively, each of the palette menus 2300, 2400, and 2500 may be called via the settings button 1320 of the screen 1300 or via the controller 1240 of FIG. 12. The palette menus 2300, 2400, and 2500 may be called together or separately. The palette menus 2300, 2400, and 2500 may be called together on the same screen or separately on different screens.

Referring to FIG. 16, the palette menu 2300 may include a plurality of submenus (2310 and 2320) corresponding to the frame of a P-App. For example, the palette menu 2300 may include a first submenu 2310, which inserts a frame into the P-App, and a second submenu 2320, which customizes the color of the frame. A determination may be made as to whether to insert a frame into the P-App via a frame button 2311 of the first submenu 2310. In this case, the second submenu 2320 may be activated only if a determination is made to insert a frame into the P-App.

In the embodiment of FIG. 16, like in some of the aforementioned embodiments, a list A of palette colors that constitute a palette 110 is displayed in the second submenu 2320. Also, an identifier B may be displayed in the second submenu 2320 to distinguish a palette color being selected by the user from other palette colors. FIG. 16 shows that a third palette color in the list A is selected in the second submenu 2320.

In the embodiment of FIG. 16, each of the palette colors in the list A may include only one partial color, and this may vary depending on the characteristics of an object to which the corresponding palette colors are to be applied. Since the frame of the P-App generally does not include any other particular elements other than itself, each of the palette colors in the list A may include only one partial color.

Referring to FIG. 17, the palette menu 2400 may include a submenu 2410 corresponding to the background and font of a P-App. In the embodiment of FIG. 17, like in some of the aforementioned embodiments, a list A of palette colors that constitute a palette 110 is displayed in the submenu 2410. Also, an identifier B may be displayed in the submenu 2410 to distinguish a palette color being selected by the user from other palette colors.

Referring to FIG. 17, each of the palette colors in the list A may include a plurality of partial colors. In one embodiment, first partial colors (i.e., background colors) of the palette colors in the list A may correspond to the background of a P-App, and second partial colors (i.e., font colors) of the palette colors in the list A may correspond to the font of the P-App. For example, the color of the background of the P-App may be customized with the first partial color of the selected palette color, and the color of the font of the P-App may be customized with the second partial color of the selected palette color.

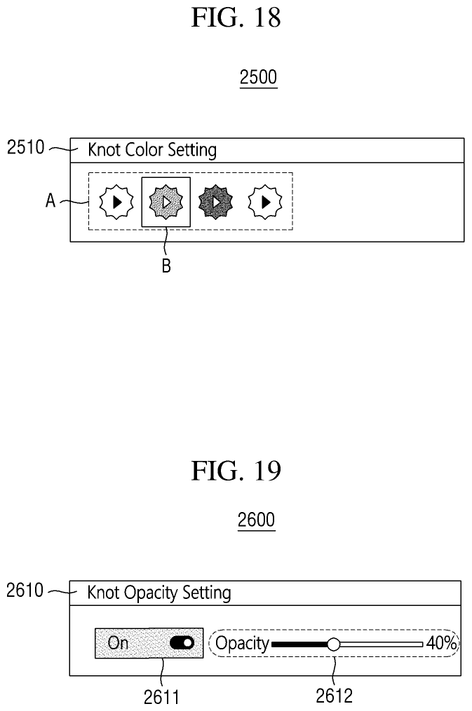

Referring to FIG. 18, the palette menu 2500 may include a submenu 2510 corresponding to a button or icon on a P-App. In the embodiment of FIG. 18, like in some of the aforementioned embodiments, a list A of palette colors that constitute a palette 110 is displayed in the submenu 2510. Also, an identifier B may be displayed in the submenu 2510 to distinguish a palette color being selected by the user from other palette colors.

Referring to FIG. 18, each of the palette colors in the list A may include a plurality of partial colors. In one embodiment, first partial colors (i.e., background colors) of the palette colors in the list A may correspond to the background of a button on a P-App, and second partial colors (the colors of the icons “ [symbol] ” in the middle) of the palette colors in the list A may correspond to an icon of the button on the P-App. For example, the color of the background of the button on the P-App may be customized with the first partial color of the selected palette color, and the color of the icon of the button on the P-App may be customized with the second partial color of the selected palette color.

FIG. 19 illustrates an opacity menu 2600 for setting the opacity of the color of an object. Referring to FIG. 19, the opacity menu 2600 includes an activation button 2611 for turning on or off an opacity control function in the submenu 2610 and a control bar 2612 for controlling the degree of opacity. The user may control the opacity of the color of an object in the range of 0% to 100% by touching and dragging the round button in the control bar 2612.

In one embodiment, the control of opacity may be performed on a palette color-by-palette color basis, a partial color-by-partial color basis, or an object-by-object basis. For example, the opacity of a particular palette color may be controlled via the control bar 2612, the opacity of one partial color of the particular palette color may be controlled all at once via the control bar 2612, or the opacity of all colors of a particular object may be controlled at once via the control bar 2612.

In one embodiment, the control of opacity may be performed not only to perform the opacity of a new color, but also to perform the opacity of an existing color. In this manner, the effect of selecting and applying a new color can be achieved simply by controlling the opacity of an existing color without the need to change the existing color or select a new color.

FIGS. 14 through 19 illustrate a case where color customization is performed on a P-App, but the present disclosure is not limited thereto. For example, the embodiments of FIGS. 14 through 19 may be directly applied to the customization of the color of content uploaded via an application, the color of a folder storing the content, or the color of a playlist, which is a list of music items. That is, the color of the content, the folder, or the playlist can be customized by calling a palette menu, selecting a palette color from a submenu of the palette menu, applying each partial color of the selected palette color to the content, the folder, or the playlist, and controlling the opacity of the color of the content, the folder, or the playlist via the control bar 2612. Here, if the selected palette color includes a plurality of partial colors, the partial colors of the selected palette color may be applied to the respective elements of the content, folder, or the playlist.

Hereinafter, an exemplary computing device 500 that can implement an apparatus and a system, according to various embodiments of the present disclosure will be described.

FIG. 20 is an example hardware diagram illustrating a computing device 500.

As shown in FIG. 20, the computing device 500 may include one or more processors 510, a memory 530 which loads a computer program 591 executed by the processors 510, a bus 550, a communication interface 570, and a storage 590 for storing the computer program 591. However, FIG. 20 illustrates only the components related to the embodiment of the present disclosure. Therefore, it will be appreciated by those skilled in the art that the present disclosure may further include other general purpose components in addition to the components shown in FIG. 20.

The processor 510 controls overall operations of each component of the computing device 500. The processor 510 may be configured to include at least one of a Central Processing Unit (CPU), a Micro Processor Unit (MPU), a Micro Controller Unit (MCU), a Graphics Processing Unit (GPU), or any type of processor well known in the art. Further, the processor 510 may perform calculations on at least one application or program for executing a method/operation according to various embodiments of the present disclosure. The computing device 500 may have one or more processors.

The memory 530 stores various data, instructions and/or information. The memory 530 may load one or more programs 591 from the storage 590 to execute methods/operations according to various embodiments of the present disclosure. An example of the memory 530 may be a volatile memory such as a RAM, but is not limited thereto.

The bus 550 provides communication between components of the computing device 500. The bus 550 may be implemented as various types of bus such as an address bus, a data bus and a control bus.

The communication interface 570 supports wired and wireless internet communication of the computing device 500. The communication interface 570 may support various communication methods other than internet communication. To this end, the communication interface 570 may be configured to comprise a communication module well known in the art of the present disclosure.

The storage 590 can non-temporarily store one or more computer programs 591. The storage 590 may be configured to comprise a non-volatile memory, such as a Read Only Memory (ROM), an Erasable Programmable ROM (EPROM), an Electrically Erasable Programmable ROM (EEPROM), a flash memory, a hard disk, a removable disk, or any type of computer readable recording medium well known in the art.

The computer program 591 may include one or more instructions, on which the methods/operations according to various embodiments of the present disclosure are implemented. When the computer program 591 is loaded on the memory 530, the processor 510 may perform the methods/operations in accordance with various embodiments of the present disclosure by executing the one or more instructions.

The technical features of the present disclosure described with reference to FIGS. 1 through 20 so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although the operations are shown in a specific order in the drawings, those skilled in the art will appreciate that many variations and modifications can be made to the preferred embodiments without substantially departing from the principles of the present invention. Therefore, the disclosed preferred embodiments of the invention are used in a generic and descriptive sense only and not for purposes of limitation. The scope of protection of the present invention should be interpreted by the following claims, and all technical ideas within the scope equivalent thereto should be construed as being included in the scope of the technical idea defined by the present disclosure.

What is claimed is:

1. A method for customizing the color of an object on an application that is driven by a computing device, comprising:
configuring a palette including at least one palette color;
displaying a color list of the palette; and
customizing the color of the object by applying a palette color selected by a user from the color list to the object,
wherein the at least one palette color includes a first partial color and a second partial color, which is distinguished from the first partial color.

2. The method of claim 1, wherein the configuring the palette, comprises displaying a possessed color list and arranging a palette color selected by the user from the possessed color list in the palette.

3. The method of claim 1, wherein
the first partial color is displayed in a first region of the at least one palette color, and
the second partial color is displayed in a second region of the at least one palette color.

4. The method of claim 3, wherein the configuring the palette, comprises changing a display location of the first partial color from the first region to the second region.

5. The method of claim 3, wherein
the first region is a background region of the at least one palette color, and
the second region is a font region of the at least one palette color.

6. The method of claim 1, wherein
one of the first and second partial colors is applied to a first element of the object, and
the other partial color is applied to a second element of the object.

7. The method of claim 6, wherein the object includes an application head, an application body, an application bottom, or a contents play bar that constitute a screen image.

8. The method of claim 6, wherein the object includes a master style or an individual element style of a “my room” displayed via the application.

9. The method of claim 6, wherein the object includes a P-App, which is a user interface tool for displaying a result of execution of an application program by the computing device or for manipulating the application program.

10. The method of claim 6, wherein the object includes content, which is uploaded via the application, a folder, which stores the content, and a playlist, which is a list of music items.

11. The method of claim 6, wherein
the first element includes a background of the object, a background of a button, a status bar, or a title bar, and
the second element includes a letter, a number, or an icon of a button.

12. The method of claim 1, wherein
the palette includes first and second palette colors, and
the configuring the palette, comprises creating a third palette color by combining a partial color of the first palette color and a partial color of the second palette color.

13. The method of claim 1, wherein
the palette includes first and second palette colors, and
the configuring the palette, comprises creating a new color by mixing a partial color of the first palette color and a partial color of the second palette color and creating a third palette color including the new color.

14. The method of claim 13, wherein the third color includes the new color as a partial color and includes at least one of the partial color of the first palette color and the partial color of the second palette color as another partial color(s).

15. The method of claim 1, wherein the at least one palette color further includes a third partial color, which is distinguished from the first and second partial colors.

16. The method of claim 15, wherein
the first partial color is displayed in a first region of the at least one palette color,
the second partial color is displayed in a second region of the at least one palette color, and
the third partial color is displayed in a third region of the at least one palette color.

17. The method of claim 16, wherein
the first region is a background region of the at least one palette color,
the second region is a font region of the at least one palette color, and
the third region is an edge region of the at least one palette color.

18. The method of claim 15, wherein
one of the first, second, and third partial colors is applied to a first element of the object,
another one of the first, second, and third partial colors is applied to a second element of the object, and
the other partial color is applied to a third element of the object or to the first or second element, instead of the rest of the first, second, and third partial colors, if a particular event occurs in the first or second element.

19. The method of claim 1, further comprising:
controlling opacity of the at least one palette color.

20. An apparatus for customizing the color of an object, comprising:
a processor;
a memory loading therein a computer program that is executed by the processor; and
a storage storing the computer program,
wherein the computer program includes instructions perform operations of configuring a palette including at least one palette color, displaying a color list of the palette, and customizing the color of the object by applying a palette color selected by a user from the color list to the object,
wherein the at least one palette color includes a first partial color and a second partial color, which is distinguished from the first partial color.
